(19) United States
(12) Patent Application Publication
(10) Pub. No.: US 2013/0106840 A1
(43) Pub. Date: May 2, 2013

(54) APPARATUS AND METHOD FOR CORRECTING IMAGE PROJECTED BY PROJECTOR

(71) Applicant: Samsung Electronics Co., Ltd., Gyeonggi-do (KR)

(72) Inventors: Gyu-Bong LEE, Gyeonggi-do (KR); Kang-Young MOON, Gyeonggi-do (KR); Yong-Chan KEH, Seoul (KR)

(73) Assignee: Samsung Electronics Co., Ltd., Gyeonggi-do (KR)

(21) Appl. No.: 13/657,361

(22) Filed: Oct. 22, 2012

(30) Foreign Application Priority Data
Oct. 20, 2011 (KR) 10-2011-0107324

(51) Int. Cl. G06T 15/04

(52) U.S. Cl. CPC G06T 15/04
USPC 345/419

(57) ABSTRACT

A projector for correcting a projected image includes an image input unit for outputting a source image; a correction parameter input unit for receiving at least one correction parameter for the source image; an image correction unit for texture-mapping the source image to a virtual 3-Dimensional (3D) object corresponding to a surface onto which a corrected image is to be displayed in order for the source image from the image input unit may be projected onto the 3D object, and then generating the corrected image obtained by applying the at least one correction parameter to the 3D object; and a projection unit for projecting the corrected image from the image correction unit onto the surface.

### PRIORITY

This application claims priority under 35 U.S.C. §119(a) to a Korean Patent Application filed in the Korean Intellectual Property Office on Oct. 20, 2011 and assigned Serial No. 10-2011-0107324, the entire content of which is incorporated herein by reference.

### BACKGROUND OF THE INVENTION

1. Field of the Invention

The present invention relates generally to an apparatus and method for correcting projection images, and more particularly, to an apparatus and method for correcting projection images using 3-Dimensional (3D) graphics.

2. Description of the Related Art

Projectors generally display images on a surface external to the projector, such as a wall, a floor, etc., as an external screen. Projectors adjust the focus and form of the screen being output (or displayed) on the external screen, in order to allow the user to clearly view the enlarged images.

In order to allow the viewer to clearly view the enlarged images, most projectors have built-in focus and zoom features. While viewing the images being projected onto the external screen, the user may adjust the focus and size of the enlarged projected images by manipulating the focus and zoom features through manual or power-assisted controls.

However, the lengths of the top and bottom and/or the lengths of the left and right sides of the screen may be different from each other depending on the installation environment of the projector. In this case, the images may be displayed on the imperfect square screen. In addition, distortions may occur even when the projection plane serving as the external screen is curved rather than flat, or when the wall or other projection surface has an uneven or intense color.

For example, when the projector is not slanted with respect to the external screen, such as shown in FIGS. 1A and 1C, images may be displayed straightforward on the external screen. However, when the projector is tilted up or down, such as shown in FIG. 1B or when the projector is tilted left or right, such as shown in FIG. 1D, images may not be displayed in a straightforward manner on the external screen.

In order to prevent these distortions of images, some projectors have features such as a built-in resolution adjustment feature, keystone feature, Color Temperature Control (CTC) feature, etc. To provide these features, such projectors include a dedicated video signal processing Integrated Circuit (IC).

Conventional projectors require the video signal processing IC to correct the distortions of images, but they may inevitably suffer from an increase in cost and power consumption due to the extra video signal processing IC. In addition, the projectors may not cope with various different types of distortions because the distortion correction the video signal processing IC may support is limited to adjustments such as keystone correction. In addition, the conventional video signal processing IC may not cope with partial stains of the screen, even though such stains may affect the overall color temperature. Further, because of the large size and high cost of video signal processing ICs, mobile terminals (or mobile projectors) with a projector module may not include a video signal processing IC. These limitations make it difficult for mobile projectors to support screen distortion corrections, such as keystone correction.

Therefore, there is a need for a method capable of correcting images in a projector without extra hardware components. In addition, there is a need for a new method that is not limited to keystone correction, and can correct images even when enlarged images are projected onto external surfaces that have various different colors, patterns, and shapes.

### SUMMARY OF THE INVENTION

An aspect of an embodiment of the present invention is to provide an apparatus and method for correcting distortion of images output from a projector without extra hardware.

Another aspect of an embodiment of the present invention is to provide an apparatus and method capable of correcting images output from a projector depending on various input parameters.

In accordance with one aspect of the present invention, there is provided a projector for correcting a projected image. The projector includes an image input unit for outputting a source image; a correction parameter input unit for receiving at least one correction parameter for the source image; an image correction unit for texture-mapping the source image to a virtual 3-Dimensional (3D) object corresponding to a surface onto which a corrected image is to be displayed in order for the source image from the image input unit may be projected onto the 3D object, and then generating the corrected image obtained by applying the at least one correction parameter to the 3D object; and a projection unit for projecting the corrected image from the image correction unit onto the surface.

In accordance with another aspect of the present invention, there is provided a method for correcting a projected image in a projector. The method includes, upon receiving a source image, receiving at least one correction parameter for the source image; texture-mapping the source image to a virtual 3-Dimensional (3D) object corresponding to a surface onto which a corrected image is to be displayed in order for the source image to be projected onto the 3D object; generating the corrected image obtained by applying the at least one correction parameter to the 3D object; and projecting the corrected image onto the surface.

### BRIEF DESCRIPTION OF THE DRAWINGS

The above and other aspects, features and advantages of certain embodiments of the present invention will be more apparent from the following description taken in conjunction with the accompanying drawings, in which:

FIGS. 1A to 1D are diagrams illustrating an operation of a conventional projector;

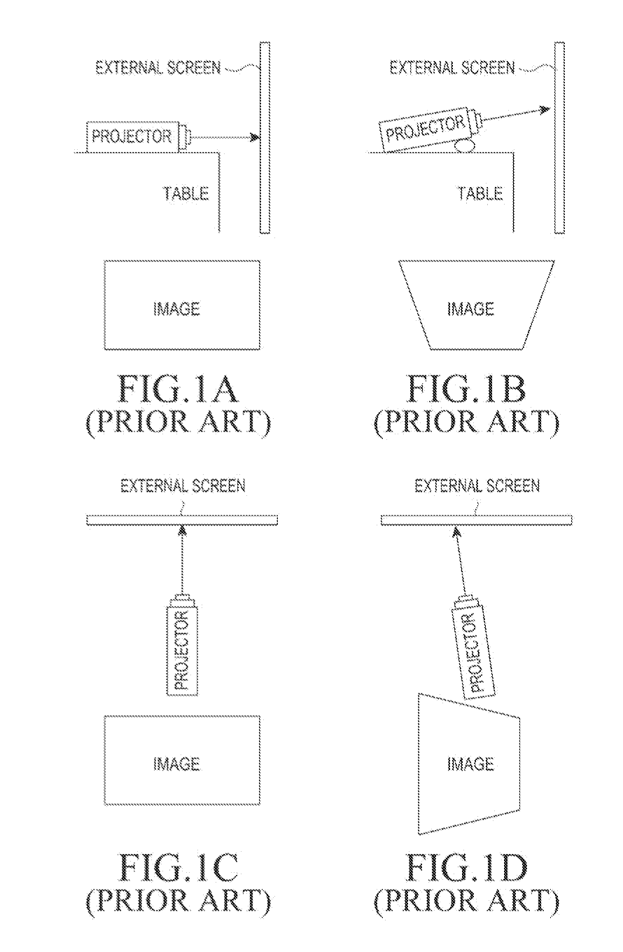

FIG. 2 is a diagram illustrating a structure of a projector according to an embodiment of the present invention;

FIG. 3 is a flow chart illustrating an operation of correcting an image in a projector according to an embodiment of the present invention;

FIG. 4 is a diagram illustrating a method of correcting an image using a 3D object according to an embodiment of the present invention; and

FIGS. 5A and 5B are diagrams illustrating an operation of projecting a corrected image according to an embodiment of the present invention.

### DETAILED DESCRIPTION OF EMBODIMENTS OF THE PRESENT INVENTION

Embodiments of the present invention are described in detail as follows with reference to the accompanying drawings. Throughout the drawings, the same drawing reference numerals may refer to the same or similar elements, features and structures. In the following description, specific details such as detailed configuration and components are provided to assist the overall understanding of embodiments of the present invention. Therefore, it should be apparent to those skilled in the art that various changes and modifications of the embodiments described herein can be made without departing from the scope and spirit of the invention. In addition, descriptions of well-known functions and constructions may be omitted for clarity and conciseness.

Embodiments of the present invention provide a method for easily correcting distortions of enlarged projected images in a projector having a projector function of projecting enlarged images onto an external screen. To this end, a projector according to embodiments of the present invention may include an image input unit for outputting an enlarged image to be projected onto the outside, a correction parameter input unit for receiving a correction value for the image, an image correction unit for texture-mapping coordinates of the image to coordinates of a 3-Dimensional (3D) object so that the image from the image input unit may be projected onto the 3D object, and then correcting the image by applying the correction value to the 3D object, and a projection unit for projecting the enlarged image corrected by the image correction unit, onto the outside. By doing performing correction in this manner, the projector may correct images without extra hardware, so it may be applied to mobile projectors. Since the projector may receive various correction parameters, the user may easily use the image correction feature.

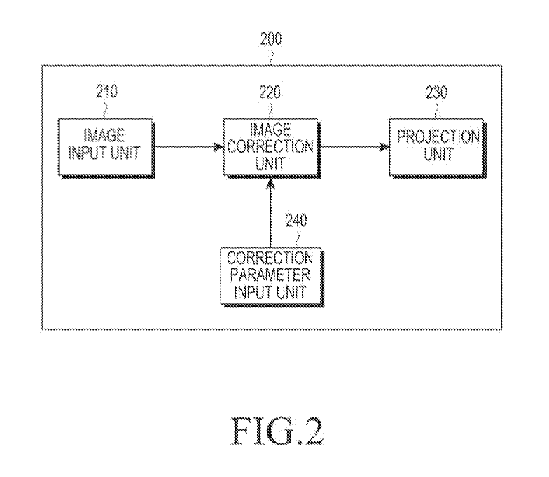

A structure of the proposed projector according to an embodiment of the present invention is described as follows with reference to FIG. 2.

FIG. 2 is a diagram illustrating a structure of a projector according to an embodiment of the present invention.

Referring to FIG. 2, a projector 200 includes an image input unit 210, an image correction unit 220, a projection unit 230, and a correction parameter input unit 240. The projector 200 may correspond to a fixed projector used for the office and residential home theaters, a mobile projector mounted in a mobile terminal, an accessory-type multimedia projector, a removable projector, etc.

The image input unit 210 receives a source image to be projected after being enlarged, from a location external to the projector 200. For example, when the projector 200 is connected to a computer, the image input unit 210 receives a source image from the computer, and when the projector 200 is connected to a mobile terminal, the image input unit 210 receives a source image from the mobile terminal. The source image may have various different input formats such as High-Definition Multimedia Interface (HDMI) or Composite Video Banking Sync (CVBS), and the image input unit 210 delivers the source image to the image correction unit 220.

The correction parameter input unit 240 detects distortion level information required by the image correction unit 220, and based thereon, determines at least one correction parameter for correcting the image. The at least one correction parameter may be determined based on an input from the user, and/or may be determined based on information detected by sensors such as an acceleration sensor, a gyro sensor, a compass sensor, etc., and/or based on camera-based recognition. The sensors serve to measure the slant of the projector 200 with respect to an external screen, which may be used in determining a view of a virtual space. The camera may be used to detect the color of the external screen or the color of an output image projected onto the external screen, and use the detected color information to determine color distortion of the captured image.

For example, if an actually-occurring keystone has an inverted ladder shape, a parameter required in a process of adjusting the image projected onto the external screen to have an opposite corresponding shape (i.e., a normal ladder shape) may be input by the user. To this end, the user may set the view of the virtual space and the view angle such that the image being projected may have a normal ladder shape. As to the view, if the projector is located on the opposite side of the location where it faces the object, i.e., if the object is located at the origin in the space and the projector is located 1 m in front of the object, then the camera in the virtual space is set to be located 1 m at the back of the object and to face the origin, with the tilted angle of the external screen set to correspond to the actual environment. The view angle is set to correspond to the throw ratio of the projector. As such, the correction parameters may include parameters such as a view angle, a view of a virtual space, a location of the 3D object, a shape of the 3D object, a size of the 3D object, a color correction of the 3D object, a stain, etc.

The image correction unit 220 generates a corrected image by processing the source image according to the correction parameter, and the generated corrected image is delivered to the projection unit 230. The image correction unit 220 has a graphic acceleration function for processing images using 3D or 2D graphics programs such as openGL and DirectX. The image correction unit 220 includes a Graphic Process Unit (GPU) for rendering a 3D object. Although types of general image distortions such as shape distortion of the image and color distortion of the external screen are considered as examples according to embodiments of the present invention, the present invention may be applied even when the image has many different types of image distortions such as when the image is output in various different colors, patterns, and shapes.

Specifically, the image correction unit 220 texture-maps coordinates of the source image to coordinates of the 3D object so that the source image from the image input unit 210 may be projected onto the 3D object. In other words, the image correction unit 220 performs texture mapping of covering the 3D object with the source image as a texture. Subsequently, the image correction unit 220 renders the 3D object, and then generates a corrected image obtained by applying the correction parameter to the 3D object. As a result, the screen seen at the view where the 3D object is set, may be actually output through the projection unit 230.

The image correction unit 220 may determine whether the image is distorted. The image distortion may be determined by comparing the non-distorted source image with a reference image captured by the camera. The image correction unit 220 may start image correction if the captured source image is different from the reference image.

The projection unit 230 serves to project the corrected image generated by the image correction unit 220 onto the external screen.

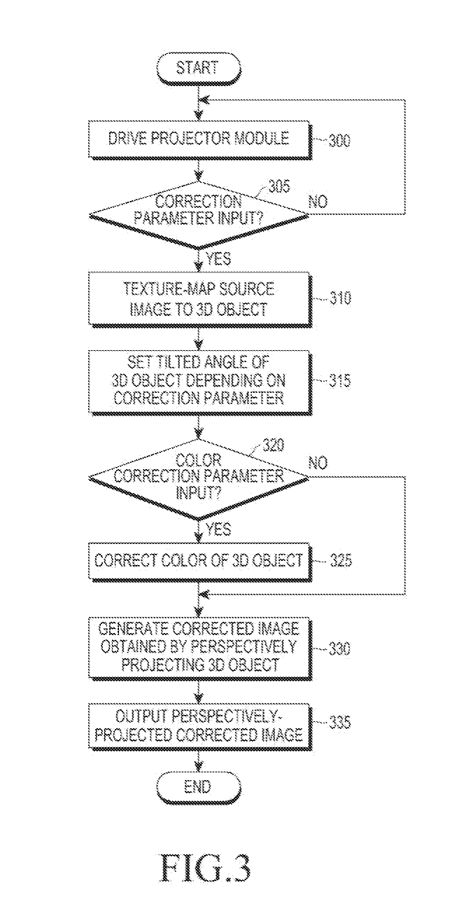

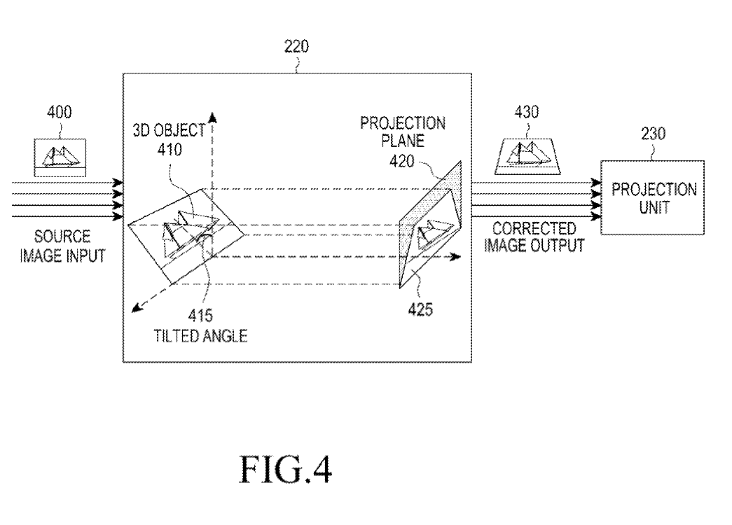

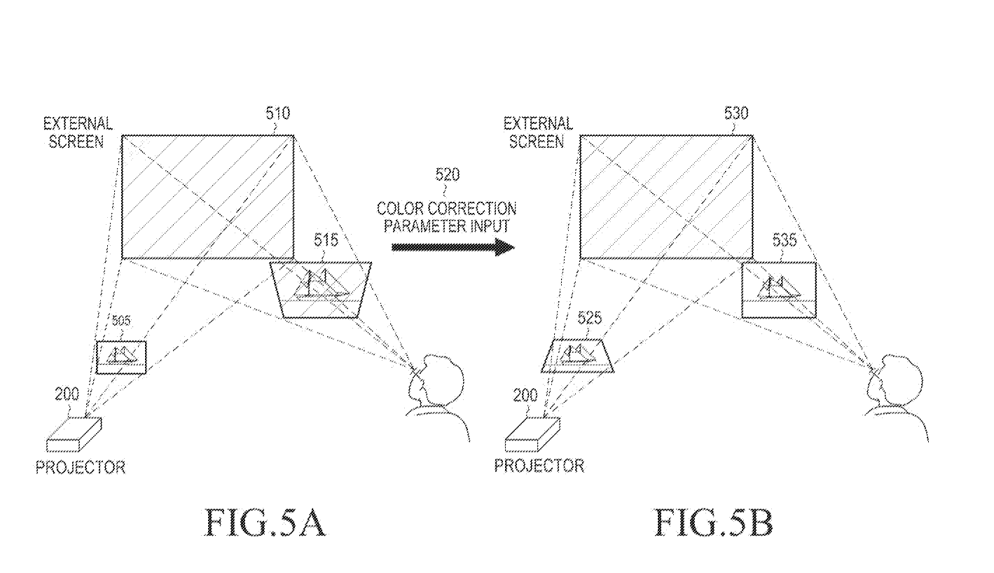

A process of correcting an image in the projector 200 described above is described as follows with reference to FIG. 3. The process of FIG. 3 is described with reference to FIGS. 4, 5A and 5B.

FIG. 3 is a flow chart illustrating an operation of correcting an image in a projector according to an embodiment of the present invention. FIG. 4 is a diagram illustrating a method of correcting an image using a 3D object according to an embodiment of the present invention. FIGS. 5A and 5B are diagrams illustrating an operation of projecting a corrected image according to an embodiment of the present invention.

Although the image correction process is described on the assumption that shape distortion of the image and color distortion of the external screen have occurred, image correction methods may be used in accordance with embodiments of the present invention.

Referring to FIG. 3, if a projector module is driven in step 300, the projector 200 projects an enlarged source image onto an external screen. In step 305, the projector 200 determines whether a correction parameter is input. If a correction parameter is input, the projector 200 texture-maps the source image to a 3D object in step 310. In step 315, the projector 200 sets a tilted angle of the 3D object depending on the correction parameter.

Referring to FIG. 4, the image correction unit 220 sets a 3D object 410 in the 3D virtual space in advance. A shape of the 3D object 410 may be designated by a correction parameter. Although the 3D objet 410 has a flat rectangular shape in FIG. 4 by way of example, it will be understood by those of ordinary skill in the art that since the external screen may not be flat, the shape of the 3D object 410 may also be freely transformed by the correction parameter to have a 3D shape (i.e., not a flat shape and corresponding to the curvature of the external screen). For example, when a source image is projected onto a spherical external screen, the 3D object 410 may also be designated by the correction parameter to have a spherical shape.

Upon receiving a source image 400, the image correction unit 220 texture-maps the source image 400 to the 3D object 410, i.e., the source image 400 is put on the 3D object 410 in a manner that matches with the shape of the 3D object 410.

Thereafter, upon receiving the source image 400, the image correction unit 220 changes the tilted angle of the 3D object 410 depending on the correction parameters (e.g., a view of the virtual space, a view angle, etc.) received in the virtual space, and then perspectively projects the angle-changed 3D object, so that an image 425 corrected to have a normal ladder shape may be displayed on a projection plane 425. The corrected image 430 is projected onto the external screen through the projection unit 230. By correcting the image in this manner, the user may view an image having same effects as the keystone-corrected image without performing keystone correction.

Although distortion of an output image is corrected using a 3D object in the foregoing description, color distortion of the output image may be corrected by changing a color of an ambient light of the 3D virtual space or a color of the 3D object in a manner similar to that described above. Accordingly, the projector 200 determines in step 320 whether a color correction parameter is input. If a color correction parameter is input, the projector 200 performs color correction on the 3D object in step 325.

For example, in the state where a white rectangular source image 505 is projected onto an external screen 510 as shown in FIG. 5A, if the external screen 510 is red and tilted, the user may view a red inverted ladder-shaped output image 515. In this case, in order for the red inverted ladder-shaped output image 515 to be seen as a white rectangular output image, a blue-green color, which complementary the red coloring may be projected, and an image given when the 3D object is perspectively projected will have a normal ladder shape and corrected colors. To this end, among the correction parameters, a color correction parameter is provided in order to project a blue-green color, and a correction parameter provided to set a shape, which is opposite to that of a keystone-distorted image, is provided.

As a result, if a color correction parameter 520 is input, the color of the ambient light of the 3D virtual space or the color of the 3D object is changed according to the input color correction parameter 520. Therefore, when the white inverted ladder-shaped source image 505 is projected as shown in FIG. 5A, a normal ladder-shaped corrected image 525 corrected by the 3D object is projected onto a red external screen 530 as shown in FIG. 5B, so the user may view a white rectangular output image 535. This color correction parameter may be directly input by the user, or may be determined by comparing the source image with a reference image on the external screen, captured by a camera.

Therefore, assuming that the external screen has a reflectivity of R:100%, G:80%, and B:80%, when a gray of Red/Blue/Green (RGB) (100,100,100) is projected, the image the user may actually view may have a reddish color of RGB(100,80,80). If a color of RGB(R*0.8, G*1, B*1), i.e., (80,100,100) is projected onto the output image to correct the color distortion, the user may view a gray of (80,80,80). In other words, the RGB values of the projected image may be modified by values according to the coloring of the external screen, such that the appearance of the modified projected image on the external screen appears to have balanced RGB values to a user observing the image on the projected screen.

Subsequently, the projector 200 generates a corrected image obtained by perspectively projecting the 3D object, in step 330, and projects the perspectively-projected corrected image onto the external screen through the projection unit 230 in step 335. As described above, the present invention may be applied not only to the keystone distortion but also other distortions, such as pincushion distortion, barrel distortion, etc., depending on the shape and location of the 3D object.

As is apparent from the foregoing description, since a projector according to embodiments of the present invention may correct images without extra hardware, the present invention is more suitable for mobile devices compared with the conventional technology, and may be applied even to mini mobile projectors. In addition, according to embodiments of the present invention, even a mobile projector may perform keystone correction and color correction desired by the user without extra cost, and therefore, the user may more conveniently use the mobile projector, thus contributing to popularization of the mobile projectors.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. A projector for correcting a projected image, comprising:
an image input unit for outputting a source image;
a correction parameter input unit for receiving at least one correction parameter for the source image;
an image correction unit for texture-mapping the source image to a virtual 3-Dimensional (3D) object corresponding to a surface onto which a corrected image is to be displayed in order for the source image from the image input unit to be projected onto the 3D object, and then generating the corrected image obtained by applying the at least one correction parameter to the 3D object; and
a projection unit for projecting the corrected image from the image correction unit onto the surface.

2. The projector of claim 1, wherein the image correction unit sets a tilted angle of the 3D object based on a correction parameter for a tilted angle of the projector from among the at least one correction parameter.

3. The projector of claim 2, wherein if a sensor measures a tilted angle of the projector, the correction parameter input unit receives a correction parameter for the tilted angle of the projector from the sensor.

4. The projector of claim 2, wherein the image correction unit generates the corrected image by perspectively projecting the 3D object tilted at the set angle.

5. The projector of claim 1, wherein the image correction unit includes a Graphic Process Unit (GPU) for rendering the 3D object.

6. The projector of claim 1, wherein the at least one correction parameter includes a parameter of at least one of a view angle set to correspond to a throw ratio of the projector, a view of a virtual space, and a location, a shape, a size, and a color correction of the 3D object.

7. The projector of claim 6, wherein upon receiving the color correction parameter from among the at least one correction parameter, the image correction unit generates the corrected image by changing a color of the 3D object according to the color correction parameter.

8. The projector of claim 6, wherein upon receiving the shape parameter from among the at least one correction parameter, the image correction unit transforms a shape of the 3D object according to the shape parameter.

9. The projector of claim 6, wherein if a sensor measures a color of the surface, the correction parameter input unit receives a correction parameter for the color of the surface from the sensor.

10. A method for correcting a projected image in a projector, comprising:
upon receiving a source image, receiving at least one correction parameter for the source image;
texture-mapping the source image to a virtual 3-Dimensional (3D) object corresponding to a surface onto which a corrected image is to be displayed in order for the source image to be projected onto the 3D object;
generating the corrected image obtained by applying the at least one correction parameter to the 3D object; and
projecting the corrected image onto the surface.

11. The method of claim 10, wherein generating a corrected image comprises setting a tilted angle of the 3D object based on a correction parameter for the tilted angle of the projector from among the at least one correction parameter.

12. The method of claim 10, further comprising:
measuring a tilted angle of the projector by a sensor; and
receiving a correction parameter for the tilted angle of the projector from the sensor.

13. The method of claim 11, wherein generating a corrected image comprises generating the corrected image by perspectively projecting a 3D object tilted at the set angle.

14. The method of claim 10, wherein the at least one correction parameter includes a parameter of at least one of a view angle set to correspond to a throw ratio of the projector, a view of a virtual space, and a location, a shape, a size, and a color correction of the 3D object.

15. The method of claim 14, wherein generating a corrected image comprises, upon receiving the color correction parameter from among the at least one correction parameter, generating the corrected image by changing a color of the 3D object according to the color correction parameter.

16. The method of claim 14, wherein generating a corrected image comprises, upon receiving the shape parameter from among the at least one correction parameter, generating the corrected image by transforming a shape of the 3D object according to the shape parameter.

17. The method of claim 14, further comprising:
measuring a color of the surface by a sensor; and
receiving a correction parameter for the color of the surface from the sensor.
